(19) United States
(12) Patent Application Publication
(10) Pub. No.: US 2010/0015379 A1
(43) Pub. Date: Jan. 21, 2010

(54) NEAR INFRARED LIGHT SHIELDING FILM

(76) Inventor: Takashi Matsushita, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/449,569

(22) PCT Filed: Feb. 19, 2008
(86) PCT No.: PCT/JP2008/053135

§ 371 Date: Aug. 13, 2009

(30) Foreign Application Priority Data
Feb. 20, 2007 (JP) 2007-039166

(51) Int. Cl. B32B 27/30; B32B 27/18; C09J 7/02; B32B 33/00

(52) U.S. Cl. 428/41.5; 428/354; 428/337; 428/345

(57) ABSTRACT

A near infrared light shielding film which comprise a hard coat layer which is formed by using a material for forming a hard coat layer comprising an agent for absorbing near infrared light and a compound curable with active energy ray and is disposed on one face of a substrate film and a pressure sensitive adhesive layer which is disposed on the other face of the substrate film, wherein the compound curable with active energy ray comprises a polyfunctional acrylate-based monomer having a functionality of five or greater as the main component. The film exhibits excellent near infrared light shielding property and transmission of visible light, excellent scratch resistance and weatherability and, moreover, excellent workability in lamination to glass having a curved surface since curling of the film is suppressed and is advantageously used for attaching to window panes of buildings and windshield glasses of automobiles and, in particular, to windshield glasses of automobiles.

### TECHNICAL FIELD

The present invention relates to a near infrared light shielding film. More particularly, the present invention relates to a near infrared light shielding film which exhibits excellent heat ray (near infrared light) shielding property and transmission of visible light, excellent scratch resistance and weatherability and, moreover, excellent workability in lamination to glass having a curved surface since curling of the film due to expansion by absorption of water is suppressed and is advantageously used for attaching to window panes of buildings and windshield glasses of automobiles and, in particular, to windshield glasses of automobiles.

### BACKGROUND ART

Open portions such as windows of buildings, vehicles, cooled showcases and refrigerated showcases have heretofore been constituted with transparent glass plates or resin plates so that sunlight can be transmitted. However, the sunlight contains ultraviolet light and near infrared light in addition to visible light. Near infrared light having wavelengths of 780 to 2,100 nm is called heat rays and causes elevation of the temperature at the inside when the light is transmitted through the open portions.

To decrease the elevation of the temperature at the inside and to save energy, means for providing the function of shielding from heat rays, which shield the windows from heat rays while visible light is sufficiently transmitted and suppress the elevation of the temperature at the inside while brightness is maintained, have been applied to the various types of windows described above. For example, a method in which a film reflecting heat rays which is obtained by forming a thin film of a metal such as aluminum, silver and gold on the surface of a substrate in the form of a transparent film in accordance with the sputtering process or the vapor deposition process is attached to a window, is disclosed (for example, refer to Patent Reference 1).

However, the film of a metal formed in accordance with the sputtering process or the vapor deposition process causes poor transmission of visible light although the film exhibits the excellent heat ray shielding property and, when the film is used for a window, drawbacks arise in that the transmission of visible light through the window is decreased, that the appearance becomes poor due to the glossy reflection with the metal, that the cost of production is inevitably increased, and that there is the possibility that the property on the electromagnetic wave is adversely affected. Therefore, films containing fine particles of inorganic agents for absorbing infrared light are being used recently.

On the surface of the films for attaching to windows described above, in general, a hard coat layer which is obtained by coating the surface of the films with a resin of the active energy ray curing type such as a polyester acrylate-based resin, an epoxy acrylate-based resin, a urethane acrylate-based resin and a polyol acrylate-based resin, followed by curing the formed coating layer is disposed so that scratch resistance is provided.

As the film containing fine particles of an inorganic agent for absorbing infrared light described above, for example, (1) heat ray shielding films in which a hard coat layer or a pressure sensitive adhesive layer contains fine particles of tin oxide doped with antimony (ATO) or fine particles of indium oxide doped with tin (ITO) (for example, refer to Patent Reference 2); (2) films having a hard coat layer which is obtained by curing a heat ray shielding resin composition comprising fine particles of ATO or ITO and a polyfunctional, active energy ray-curable (meth)acrylate having (meth)acryloyl group (for example, refer to Patent Reference 3); (3) infrared light shielding films having an infrared light shielding hard coat layer which comprises a cured coating film of a resin of the ionizing radiation curing type and a rare earth metal-based infrared light shielding agent (for example, refer to Patent Reference 4); and (4) films obtained by forming a infrared light shielding film by coating a polyethylene terephthalate film with a coating fluid obtained by mixing fine particles of tungsten oxide, which exhibit more excellent infrared light shielding property than that of ATO or ITO, with a ultraviolet light-curable resin for a hard coat, followed by curing the formed coating film (for example, refer to Patent Reference 5); are disclosed.

When a film is laminated to a window pane of a building or a windshield glass of an automobile, an aqueous solution of a surfactant as a processing fluid is sprayed to the surface of a pressure sensitive adhesive layer in the film so that the air left remaining at the interface of the glass face and the film is removed.

For buildings, in general, a substrate film having a great thickness of about 50 to 500 μm is used since the property for preventing scattering of pieces of glasses when the glasses are broken and the property for preventing theft are required. On the other hand, for automobiles, a substrate film having a small thickness of about 10 to 50 μm is used since the film is attached to the concave face (the inner face) of the windshield glass after the film is shrink molded by heating in a manner such that the film has a shape fitting the convex face (the outer face) of the windshield glass having a curved shape (for example, refer to Patent Reference 6).

An example of the steps for attaching a film to a windshield glass of an automobile is schematically shown in the following. A film which has a hard coat layer on one face of a substrate film and a release film on the other face of the substrate film via a pressure sensitive adhesive layer is used.

(1) A processing fluid is sprayed to the convex face of the windshield glass, and the film is temporarily fixed to the windshield glass in a manner such that the face of the film having the hard coat layer is brought into contact with the convex face of the glass.

(2) The film is shrink molded by heating into a shape fitting the convex face of the windshield glass while the heated air is applied to the film.

(3) The processing fluid is sprayed to the surface of the pressure sensitive adhesive while the release film is removed from the film.

(4) The film is removed from the convex face of the windshield glass.

(5) The film is temporarily fixed to the concave face (the inner face) of the windshield glass in a manner such that the surface of the pressure sensitive adhesive layer of the film is brought into contact with the inner face of the windshield glass.

(6) The processing fluid and the air left remaining at the interface of the glass and the film are wiped out by using a squeegee.

In accordance with the process for laminating the film described above, the hard coat layer absorbs the processing fluid in step (1) described above, and the hard coat layer is expanded relative to the substrate film. However, curling of the film is suppressed in this step since the release film having a thickness of 25 μm or 38 μm is laminated. In further steps, when the release film is removed from the film in step (3) and the film is removed from the convex face of the windshield glass in step (4), the film is curled due to expansion of the hard coat layer in a manner such that the face of the film having the pressure sensitive adhesive is placed at the inside as shown in FIG. 1. The face of the pressure sensitive adhesive is adhered to the face of the hard coat layer, and this causes a problem in steps (5) and (6). This phenomenon arises markedly when fine particles of an inorganic agent for absorbing infrared light are dispersed into the hard coat layer using a dispersant.

[Patent Reference 1] Japanese Patent Application Laid-Open No. Showa 57(1982)-59749

[Patent Reference 2] Japanese Patent Application Laid-Open No. Heisei 8(1996)-281860

[Patent Reference 3] Japanese Patent Application Laid-Open No. Heisei 9(1997)-108621

[Patent Reference 4] Japanese Patent Application Laid-Open No. 2000-318090

[Patent Reference 5] Pamphlet for WO 2005/037932

[Patent Reference 6] Japanese Patent No. 3026070

### DISCLOSURE OF THE INVENTION

### [Problems to be Overcome by the Invention]

Under the above circumstances, the present invention has an object of providing a near infrared light shielding film which exhibits excellent near infrared light shielding property and transmission of visible light, excellent scratch resistance and weatherability and, moreover, excellent workability in lamination to glass having a curved surface since curling of the film due to expansion by absorption of water is suppressed and is advantageously used for attaching to window panes of buildings and windshield glasses of automobiles and, in particular, to windshield glasses of automobiles.

### [Means for Overcoming the Problems]

As the result of intensive studies by the present inventors to develop the near infrared light shielding film exhibiting the advantageous properties described above, the following knowledge was obtained.

In designing the hard coat layer, in general, it is conducted frequently that oligomers, not monomers, are used mainly as the compound curable with active energy ray and the number of the polymerizable functional group is decreased so that curling due to shrinking by curing is suppressed.

As opposed to the conventional way of thinking in designing, it was found that curling due to expansion by absorption of water could be suppressed in the applications of the present invention when a monomer was used mainly as the compound curable with active energy ray and the number of the polymerizable functional group was increased

When the compound curable with active energy ray is cured with ultraviolet light, there is the tendency that the inorganic agent for absorbing infrared light absorbs ultraviolet light which excites the photopolymerization initiator and curing with ultraviolet light becomes insufficient, and this phenomenon can be considered to be a cause of the curling due to expansion by absorption of water. Therefore, it was attempted that the wavelength for exciting the photopolymerization initiator was shifted to a range where the absorption with the inorganic agent for absorbing infrared light did not take place, and that the amount of the photopolymerization initiator was increased. However, the hardness sufficient for suppressing the curling due to expansion by absorption of water could not be obtained although the scratch resistance (the hardness sufficient for preventing formation of scratches during application of a squeegee) could be obtained. The above phenomenon arises more markedly when tungsten oxide was used than when ATO or ITO was used since tungsten oxide absorbs ultraviolet light in a wider range of the wavelength.

To overcome the above problem, it was found that the curling due to expansion by absorption of water could be suppressed by using 2-hydroxy-1-[4-[4-(2-hydroxy-2-methylpropionyl)benzyl]phenyl]-2-methyl-propan-1-one as the photopolymerization initiator.

The present invention has been completed based on the above knowledge.

The present invention provides:
[1] A near infrared light shielding film which comprise a hard coat layer which is formed by using a material for forming a hard coat layer comprising an agent for absorbing near infrared light and a compound curable with active energy ray and is disposed on one face of a substrate film and a pressure sensitive adhesive layer which is disposed on an other face of the substrate film, wherein the compound curable with active energy ray comprises a polyfunctional acrylate-based monomer having a functionality of five or greater as a main component;
[2] The near infrared light shielding film described in [1], wherein the substrate film has a thickness of 50 μm or smaller;
[3] The near infrared light shielding film described in any one of [1] and [2], wherein the agent for absorbing near infrared light is a tungsten oxide;
[4] The near infrared light shielding film described in [3], wherein the tungsten oxide is a composite tungsten oxide comprising cesium;
[5] The near infrared light shielding film described in any one of [3] and [4], wherein a content of the tungsten oxide in the hard coat layer is 5 to 60% by mass;
[6] The near infrared light shielding film described in any one of [1] to [5], wherein the material for forming a hard coat layer comprises a photopolymerization initiator, and the hard coat layer is formed by irradiation with ultraviolet light;
[7] The near infrared light shielding film described in [6], wherein the photopolymerization initiator is 2-hydroxy-1-[4-[4-(2-hydroxy-2-methylpropionyl)benzyl]phenyl]-2-methylpropan-1-one;
[8] The near infrared light shielding film described in any one of [1] to [7], which is attached to glass having a curved surface; and
[9] A material for the near infrared light shielding film which is described in any one of [1] to [7], wherein the pressure sensitive adhesive layer has a release film adhered to a face opposite to the face adhered to the substrate film.

### THE EFFECT OF THE INVENTION

In accordance with the present invention, the near infrared light shielding film which exhibits excellent near infrared light shielding property and transmission of visible light, excellent scratch resistance and weatherability and, moreover, excellent workability in lamination to glass having a curved surface since curling of the film due to expansion by absorption of water is suppressed and is advantageously used for attaching to window panes of buildings and windshield glasses of automobiles and, in particular, to windshield glasses of automobiles can be provided.

### BRIEF DESCRIPTION OF THE DRAWINGS

FIG. 1 shows a diagram exhibiting the condition in which a film is curled in a manner such that the face of the film having the pressure sensitive adhesive is placed at the inside.

FIGS. 2(a), 2(b), 2(c), 2(d) and 2(e) show diagrams exhibiting the degree of curling due to shrinking by curing in near infrared light shielding films obtained in Examples and Comparative Examples for evaluation of the degree.

FIGS. 3(a), 3(b), 3(c) and 3(d) show diagrams exhibiting the degree of curling due to expansion by absorption of water in near infrared light shielding films obtained in Examples and Comparative Examples for evaluation of the degree.

FIG. 4 shows a diagram exhibiting the transmittance curve of a near infrared light shielding film obtained in Example 1.

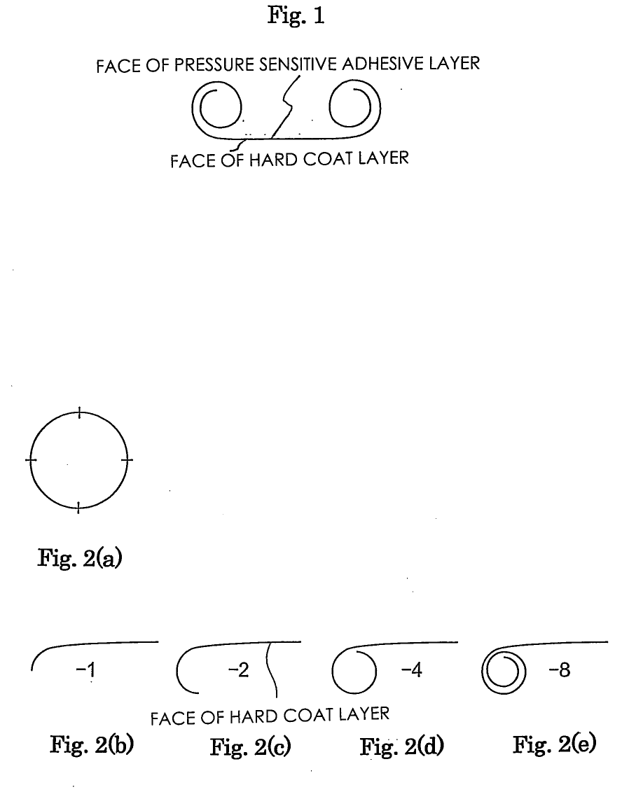

### THE MOST PREFERRED EMBODIMENT TO CARRY OUT THE INVENTION

The near infrared light shielding film of the present invention is a film having a structure such that a hard coat layer which is formed by using a material for forming a hard coat layer comprising an agent for absorbing near infrared light and a compound curable with active energy ray is disposed on one face of a substrate film and a pressure sensitive adhesive layer is disposed on the other face of the substrate film.

The substrate film used for the near infrared light shielding film is not particularly limited, and a film can be suitably selected from various transparent plastic films in accordance with the situation. Examples of the transparent plastic film include films of polyolefin-based resins such as polyethylene, polypropylene, poly-4-methylpentene-1 and polybutene-1, polyester-based resin such as polyethylene terephthalate and polyethylene naphthalate, polycarbonate-based resins, polyvinyl chloride-based resins, polyphenylene sulfide-based resins, polyether sulfone-based resins, polyethylene sulfide-based resins, polyphenylene ether-based resins, styrene-based resins, acrylic resins, polyamide-based resins, polyimide-based resins and cellulose-based resins such as cellulose acetate and laminate films based on these films. Among these films, films of polyethylene terephthalate are preferable.

The thickness of the substrate film is not particularly limited and is suitably selected in accordance with the object of the use of the near infrared light shielding film. In general, the thickness is 10 to 500 μm. When the film is shrink molded by heating for application to glass having a curved surface, it is preferable that the thickness is 50 μm or smaller. When the thickness exceeds 50 μm, curling due to expansion by absorption of water is suppressed even when the hard coat layer contains tungsten oxide which is an inorganic agent for absorbing infrared light tending to cause curling due to expansion by absorption of water and the means of the present invention described below is not applied to the hard coat layer. However, when the thickness is 50 μm or smaller, in particular, when the thickness is 38 μm or smaller and, further, when the thickness is 25 μm or smaller, curling due to expansion by absorption of water takes place very markedly, and the present invention is effective in these cases. From the standpoint of the property for forming the hard coat layer, it is preferable that the thickness is 10 μm or greater and more preferably 20 μm or greater.

Where desired, the substrate film may be colored, may have a film formed by vapor deposition and may comprise antiweathering agents such as antioxidants, ultraviolet light absorbents and photostabilizers. Where desired, the substrate film may be treated by a surface treatment such as an oxidation treatment or a roughening treatment on one or both faces thereof so that adhesion with a layer formed on the surface of the substrate film is enhanced. Examples of the oxidation treatment include the treatment by corona discharge, the treatment with plasma, the treatment with chromic acid (the wet process), the treatment with flame, the treatment with the heated air and the treatment with ozone with irradiation with ultraviolet light. Examples of the roughening treatment include the sand blast treatment and the treatment with solvents. The surface treatment is suitably selected in accordance with the type of the substrate film. In general, the treatment by corona discharge is preferable from the standpoint of the effect and the operability. A primer layer may be formed.

In the near infrared light shielding film of the present invention, the hard coat layer disposed on one face of the substrate film is a hard coat layer absorbing near infrared light which is formed by using a material for forming a hard coat layer comprising an agent for absorbing near infrared light and a compound curable with active energy ray.

As the agent for absorbing near infrared light comprised in the material for forming a hard coat layer, tungsten oxide which is an inorganic agent for absorbing near infrared light is preferable from the standpoint of the weatherability, the property for absorbing near infrared light and the transmission of visible light, and composite tungsten oxide is more preferable.

Examples of the composite tungsten oxide described above include compounds represented by general formula (1):

MₘWOₙ (1)

wherein M represents at least one element selected from H, He, alkali metals, alkaline earth metals, rare earth elements, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi and I; and m and n each represent a number satisfying the relations of 0.001≦m≦1.0 and 2.2≦n≦3.0.

It is preferable that the composite tungsten oxide represented by general formula (1) has at least one crystal structure selected from the crystal structures of the hexagonal system, the tetragonal system and the cubic system since the composite tungsten oxide exhibits excellent durability when the composite tungsten oxide has a crystal structure selected from the crystal structures of the hexagonal system, the tetragonal system and the cubic system. Among these crystal structures, the crystal structure of the hexagonal system is more preferable since the absorption of light in the visible region is the smallest in the case of the crystal structure of the hexagonal system. Examples of the composite tungsten oxide having the crystal structure of the hexagonal system include composite tungsten oxides comprising at least one element selected from Cs, Rb, K, Tl, In, Ba, Li, Ca, Sr, Fe and Sn as the preferable element represented by M.

It is preferable that the amount represented by m of the element represented by M in the composite tungsten oxide is 0.001 or greater and 1.0 or smaller and preferably about 0.33. This value is preferable since the value of m theoretically calculated from the crystal structure of the hexagonal system is 0.33, and the advantageous optical property as the agent for absorbing near infrared light is obtained when the amount is in the vicinity of this value. It is preferable that the amount of oxygen represented by n is 2.2 or greater and 3.0 or smaller. Typical examples include Cs_{0.33}WO₃, Rb_{0.33}WO₃, K_{0.33}WO₃ and Ba_{0.33}WO₃. When the values represented by m and n are within the above ranges, the advantageous property for absorption of near infrared light can be obtained.

In the present invention, the composite tungsten oxide comprising cesium is preferable as the composite tungsten oxide from the standpoint of the optical property and the weatherability as the agent for absorbing near infrared light. Examples of the composite tungsten oxide comprising cesium include compounds represented by general formula (1-a):

Cs_{0.2˜0.4}WO_{2.5˜3.0} (1-a)

The composite tungsten oxide described above exhibits remarkably more excellent weatherability than that exhibited with phthalocyanine compounds comprising fluorine which is known to exhibit very excellent weatherability and, moreover, the composite tungsten oxide exhibits great transmission of visible light.

It is preferable that the composite tungsten oxide is used in the form of fine particles. It is preferable that the average diameter of the particles is 800 nm or smaller and more preferably 100 nm or smaller from the standpoint of the property for dispersion and the optical property.

In the present invention, the composite tungsten oxide may be used singly or in combination of two or more. The content of the composite tungsten oxide in the solid components in the material for forming a hard coat layer is, in general, 5 to 60% by mass and preferably 10 to 40% by mass from the standpoint of the property for absorbing near infrared light, the property for dispersion and the properties as the hard coat layer.

Even when ATO or ITO is used as the inorganic agent for absorbing near infrared light, curling due to expansion by absorption of water takes place, and the present invention exhibits the effect of suppressing the curling in this case. However, the curling takes place to a greater degree when tungsten oxide is used, and the effect of the present invention is exhibited more remarkably when tungsten oxide is used.

In the present invention, where desired, other inorganic agents for absorbing infrared light and organic agents for absorbing infrared light can be suitably used in combination with the composite tungsten oxide as long as the effect of the present invention is not adversely affected.

Examples of the other inorganic agent for absorbing infrared light include tungsten oxide-based compounds other than the composite tungsten oxides, titanium oxide, zirconium oxide, tantalum oxide, niobium oxide, zinc oxide, indium oxide, indium oxide doped with tin (ITO), tin oxide, tin oxide doped with antimony oxide (ATO), cesium oxide, zinc sulfide and hexaborides such as LaB₆, CeB₆, PrB₆, NdB₆, GdB₆, TbB₆, DyB₆, HoB₆, YB6, SmB₆, EuB₆, ErB₆, TmB₆, YbB₆, LuB₆, SrB₆, CaB₆ and (La, Ce)B₆.

Examples of the organic agent for absorbing infrared light include cyanine-based compounds; squalirium-based compounds; thiol nickel complex salt-based compounds; naphthalocyanine-based compounds; phthalocyanine-based compounds; triallylmethane-based compounds; naphthoquinone-based compounds; anthraquinone-based compounds; amino compounds such as perchloric acid salt of N,N,N′,N′-tetrakis-(p-di-n-butylaminophenol)-p-phenylenediaminium, chlorine salt of phenylenediaminium, hexafluoroantimonic acid salt of phenylenediaminium, fluoroboric acid salt of phenylenediaminium, fluorine salt of phenylenediaminium and perchloric acid salt of phenylenediaminium; copper compounds and bisthiourea compounds; phosphorus compounds and copper compounds; and phosphoric acid ester copper compounds obtained by the reaction of phosphoric acid esters and copper compounds.

Among these compounds, thiol nickel complex salt-based compounds (Japanese Patent Application Laid-Open No. Heisei 9(1997)-230134) and phthalocyanine-based compounds are preferable, and phthalocyanine compounds having fluorine disclosed in Japanese Patent Application Laid-Open No. 2000-26748 are more preferable as the agent used in combination with the composite tungsten oxide due to the great transmission of visible light and excellent properties such as excellent heat resistance, light resistance and weatherability.

The compound curable with active energy ray comprised in the material for forming a hard coat layer is a compound which is crosslinked and cured by irradiation with ray having energy quantum among electromagnetic waves and charged particles such as ultraviolet light and electron beams.

Heretofore, for forming the hard coat layer, in general, a material comprising an oligomer polymerizable with active energy ray having a small number of the polymerizable function group such as a polyester acrylate-based oligomer, an epoxy acrylate-based oligomer, a urethane acrylate-based oligomer and polyol acrylate-based oligomers as the main component and a monomer polymerizable with active energy ray as an added component have been used so that curling due to shrinking by curing is decreased.

In the present invention, a material comprising polyfunctional acrylate-based monomers having a functionality of five or greater as the main components is used as the compound curable with active energy ray. Curling due to expansion by absorption of water can be effectively suppressed by using the above material. That the compound curable with active energy ray comprises polyfunctional acrylate-based monomers having a functionality of five or greater as the main components means that the compound curable with active energy ray comprises the polyfunctional acrylate-based monomers having a functionality of five or greater in an amount of 50% by mass or greater of the entire compound.

Examples of the polyfunctional acrylate-based monomers having a functionality of five or greater include dipentaerythritol pentaacrylate, dipentaerythritol pentaacrylate modified with propionic acid, dipentaerythritol hexaacrylate, dipentaerythritol hexaacrylate modified with caprolactone, dipentaerythritol pentamethacrylate, dipentaerythritol pentamethacrylate modified with propionic acid, dipentaerythritol hexamethacrylate and dipentaerythritol hexamethacrylate modified with caprolactone. Among these compounds, dipentaerythritol pentaacrylate and dipentaerythritol hexaacrylate are preferable. In the present invention, the polyfunctional acrylate-based monomer may be used singly or in combination of two or more.

In the present invention, where desired, oligomers polymerizable with active energy ray and/or monomers polymerizable with active energy ray having a functionality of four or smaller may be used as the compound curable with active energy ray in combination with the polyfunctional acrylate-based monomers having a functionality of five or greater as long as the effect of the present invention is not adversely affected.

Examples of the oligomer polymerizable with active energy ray include polyester acrylate-based oligomers, epoxy acrylate-based oligomers, urethane acrylate-based oligomers and polyol acrylate-based oligomers. The oligomer polymerizable with active energy ray may be used singly or in combination of two or more.

Examples of the monomer polymerizable with active energy ray having a functionality of four or smaller include monofunctional acrylates such as cyclohexyl(meth)acrylate, 2-ethylhexyl(meth)acrylate, lauryl(meth)acrylate, stearyl(meth)acrylate and isobornyl(meth)acrylate; and polyfunctional acrylates having a functionality of four or smaller such as 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, hydroxypivalic acid neopentyl glycol di(meth)acrylate, dicyclopentanyl di(meth)acrylate, dimethylol-tricyclodecane di(meth)acrylate, dicyclopentenyl di(meth)acrylate modified with caprolactone, phosphoric acid di(meth)acrylate modified with ethylene oxide, cyclohexyl di(meth)acrylate modified with allyl group, isocyanurate di(meth)acrylate, trimethylolpropane tri(meth)acrylate, dipentaerythritol tri(meth)acrylate, dipentaerythritol tri(meth)acrylate modified with propionic acid, pentaerythritol tri(meth)acrylate, trimethylolpropane tri(meth)acrylate modified with propylene oxide and tris(acryloxyethyl)isocyanurate. The monomer polymerizable with active energy ray having a functionality of four or smaller may be used singly or in combination of two or more.

It is preferable that the material for forming a hard coat layer in the present invention forms a hard coat layer by curing with ultraviolet light when formation of damages on the substrate film and the productivity are considered. In this case, in general, a photo-polymerization initiator is added to the material for forming a hard coat layer. As the photopolymerization initiator, a suitable compound is selected from conventional photopolymerization initiators. Examples of the photopolymerization initiator include benzoin, benzoin methyl ether, benzoin ethyl ether, benzoin isopropyl ether, benzoin n-butyl ether, benzoin isobutyl ether, acetophenone, dimethylaminoacetophenone, 2,2-dimethyl-2-phenylacetophenone, 2,2-diethoxy-2-phenylacetophenone, 2-hydroxy-2-methyl-1-phenylpropan-1-one, 2-hydroxy-1-[4-[4-(2-hydroxy-2-methylpropionyl)benzyl]phenyl]-2-methylpropan-1-one, 1-hydroxycyclohexyl phenyl ketone, 2-methyl-1-[4-(methylthio)phenyl]-2-morpholinopropan-1-one, 4-(2-hydroxyethoxy)phenyl-2-(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tertiary-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, 2,4,6-trimethylbenzoyldiphenylphosphine oxide, 2,4,6-trimethylbenzoylphenylethoxyphosphine oxide, bis(2,6-dimethoxybenzoyl)-2,4,4-trimethylpentylphosphine oxide and bis(2,4,6-trimethylbenzoyl)-phenylphosphine oxide.

In the present invention, one or more photopolymerization initiators having a wavelength of excitation different from the wavelength of ultraviolet light absorbed with the inorganic agent for absorbing near infrared light used above are selected from these photopolymerization initiators from the standpoint of the property for photocuring.

For example, when a composite tungsten oxide comprising cesium is used as the agent for absorbing near infrared light, it is preferable that 2-hydroxy-1-[4-[4-(2-hydroxy-2-methylpropionyl)benzyl]phenyl]-2-methyl-propan-1-one [manufactured by CIBA SPECIALTY CHEMICALS Co., Ltd.; the trade name: IRGACURE 127] is used as the photopolymerization initiator.

The amount of the photopolymerization initiator is selected, in general, in the range of 1 to 15 parts by mass and preferably in the range of 2 to 10 parts by mass based on 100 parts by mass of the compound curable with active energy ray.

In the present invention, photosensitizers may be used in combination with the photopolymerization initiator. Examples of the photosensitizer include tertiary amines such as N,N-dimethylaminobenzoic acid ethyl ester, N,N-dimethylaminobenzoic acid isoamyl ester, pentyl 4-dimethylaminobenzoate, triethylamine and triethanolamine. The photosensitizer may be used singly or as a mixture of two or more.

The material for forming a hard coat layer can be prepared by mixing the agent for absorbing near infrared light and the compound curable with active energy ray described above, the photopolymerization initiator and the photosensitizer described above which are used where desired and various types of additives such as antioxidants, light stabilizers, leveling agents and defoaming agents in each specific amounts. In the preparation, where desired, solvents may be added so that the concentrations and the viscosity are adjusted at values suitable for coating.

Examples of the solvent used in the above include aliphatic hydrocarbons such as hexane, heptane and cyclohexane, aromatic hydrocarbons such as toluene and xylene, halogenated hydrocarbons such as methylene chloride and ethylene chloride, alcohols such as methanol, ethanol, propanol, butanol and 1-methoxy-2-propanol, ketones such as acetone, methyl ethyl ketone, 2-pentanone, methyl isobutyl ketone and isophorone, esters such as ethyl acetate and butyl acetate and cellosolve-based solvents such as ethylcellosolve.

One face of the substrate film is coated with the material for forming a hard coat layer prepared as described above in accordance with a conventional process such as the bar coating process, the knife coating process, the roll coating process, the blade coating process, the die coating process and the gravure coating process to form a coating film, and the formed coating film is dried. Then, the dried coating film is irradiated with active energy ray to cure the coating film, and a hard coat layer comprising the agent for absorbing near infrared light is formed.

Examples of the active energy ray include ultraviolet light and electron beams. Ultraviolet light can be obtained from a high voltage mercury lamp, a fusion H lamp or a xenon lamp. Electron beams can be obtained from an electron accelerator. Among these active energy rays, ultraviolet light is preferable. When electron beams are used, the hard coat layer can be obtained without adding the photopolymerization initiator.

The thickness of the hard coat layer obtained as described above is, in general, about 1 to 10 μm and preferably 1 to 5 μm.

It is necessary that the near infrared light shielding film of the present invention have a hardness sufficient for suppressing expansion due to absorption of water with the hard coat layer. It is preferable that the dynamic hardness as the index expressing this property is 20 or greater.

The hard coat layer described above has a great hardness to exhibit excellent scratch resistance and exhibits excellent property for absorbing near infrared light and excellent transmission of visible light. When the fine particles of the composite tungsten oxide comprising cesium is used as the agent for absorbing near infrared light, the spectroscopic transmittance over the entire range of the wavelength of 780 to 2,100 nm is, in general, 50% or smaller to exhibit the excellent near infrared light shielding function, and the spectroscopic transmittance at the wavelength of 550 nm is, in general, 70% or greater. Moreover, weatherability is excellent.

In the near infrared light shielding film of the present invention, where necessary, an antifouling coating layer may be disposed on the hard coat layer. The antifouling coating layer can be formed, in general, by coating the hard coat layer with a coating fluid comprising a fluorine-based resin in accordance with a conventional process such as the bar coating process, the knife coating process, the roll coating process, the blade coating process, the die coating process and the gravure coating process to form a coating fluid, followed by drying the formed coating film.

The thickness of the antifouling coating film is, in general, in the range of 0.001 to 10 μm and preferably in the range of 0.01 to 5 μm. By forming the antifouling coating layer, the surface of the obtained near infrared light shielding film exhibits an improved slipping property, and fouling of the surface is suppressed.

In the near infrared light shielding film of the present invention, a pressure sensitive adhesive layer is disposed on the face of the substrate film opposite to the face having the hard coat layer. The pressure sensitive adhesive constituting the pressure sensitive adhesive layer is not particularly limited, and a suitable pressure sensitive adhesive can be selected from various conventional pressure sensitive adhesives in accordance with the situation. From the standpoint of the weatherability, acrylic pressure sensitive adhesives, urethane-based pressure sensitive adhesives and silicone-based pressure sensitive adhesives are preferable. The thickness of the pressure sensitive adhesive layer is, in general, in the range of 1 to 100 μm and preferably in the range of 2 to 50 μm.

The pressure sensitive adhesive layer may comprise antiweathering agents such as ultraviolet light absorbents, light stabilizers and antioxidants, where necessary.

In the near infrared light shielding film of the present invention, a release film may be attached to the pressure sensitive adhesive film described above. Examples of the release film include release films prepared by coating plastic films, examples of which include films of polyesters such as polyethylene terephthalate, polybutylene terephthalate and polyethylene naphthalate and polyolefins such as polypropylene and polyethylene, with a releasing agent. As the releasing agent, silicone-based releasing agents, fluorine-based releasing agents and long chain alkyl-based releasing agents can be used. Among these releasing agents, silicone-based releasing agents are preferable since stable properties can be obtained at a low cost. The thickness of the release film is not particularly limited and is, in general, about 20 to 250 μm and preferably 20 to 50 μm when the shrink molding by heating is conducted.

For attaching the release film to the pressure sensitive adhesive layer, the face of the release film having the layer of the releasing agent is coated with a pressure sensitive adhesive to form a pressure sensitive adhesive layer having the prescribed thickness. The obtained laminate is attached to the face of the substrate film opposite to the face having the hard coat layer so that the pressure sensitive adhesive layer is transferred. The release film is left being attached.

The near infrared light shielding film of the present invention exhibits excellent near infrared light shielding property and transmission of visible light, excellent scratch resistance and weatherability and, moreover, excellent workability in lamination to glass having a curved surface since curling of the film due to expansion by absorption of water is suppressed.

Therefore, the elevation of temperature at the inside can be suppressed and the use of energy can be decreased by attaching the near infrared light shielding film of the present invention to window panes of buildings, windshield glasses of vehicles and windows of cooled showcases and refrigerated showcases. In particular, the film is advantageously used by attaching to curved glass faces of windows of vehicles such as windshield glasses of vehicles.

### Examples

The present invention will be described more specifically with reference to examples in the following. However, the present invention is not limited to the examples.

Properties of near infrared light shielding films obtained in Examples and Comparative Examples were obtained in accordance with the following methods.

### (1) Curling Due to Shrinking by Curing

A rectangular sample having a size of 1,000 mm×600 mm was held at the longer edge and suspended vertically. The shape of curling of the other dangling edge was expressed by the number of arcs on the other edge.

FIG. 2(a) to FIG. 2(e) show diagrams for describing the method for evaluating degree of curling due to shrinking by curing. The circumference of a circle was divided into four arcs [FIG. 2(a)], and the degree of curling was expressed by the number of arcs [specifically, −1 in FIG. 2(b), −2 in FIG. 2(c), −4 in FIG. 2(d) and −8 in FIG. 2(e)]. The curling formed in a manner such that the face having the hard coat layer was placed at the inside was expressed by a minus value. The degree of the curling due to shrinking by curing was decreased when the film was molded by heating due to shrinking of the substrate film. Therefore, cleavage did not take place after the working when the degree of curling was −6 or smaller.

### (2) Curling Due to Expansion by Absorption of Water

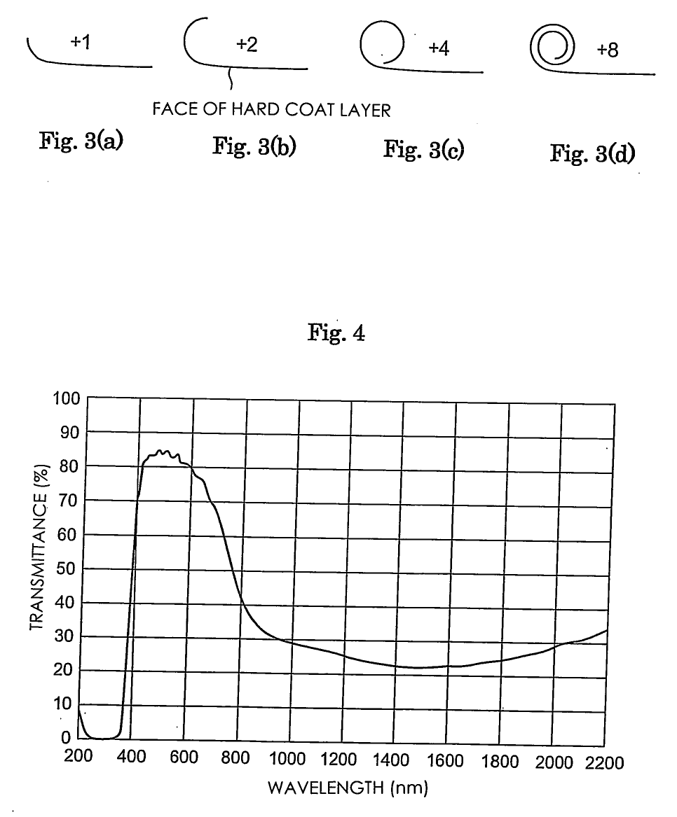

A 0.1% aqueous solution of a neutral detergent for kitchens was sprayed on the entire face of a hard coat layer, and the degree of curling was expressed by the number of arcs in a manner similar to that in (1) described above. FIG. 3(a) to FIG. 3(d) show diagrams for describing the method for evaluating degree of curling due to expansion by absorption of water, and the degree of curling was expressed by the number of arcs [specifically, +1 in FIG. 3(a), +2 in FIG. 3(b), +4 in FIG. 3(c) and +8 in FIG. 3(d)]. The curling formed in a manner such that the face having the hard coat layer was placed at the outside was expressed by a plus value. In the curling due to expansion by absorption of water, it is preferable that the above value was +4 or smaller so that the pressure sensitive adhesive layer was not adhered to the hard coat layer.

### (3) Scratch Resistance

Using GAKUSHIN Rubbing Tester, a sample was rubbed with steel wool #0000 under a weight having a mass of 200 g in 10 reciprocal movements, and the presence or the absence of scratches was examined by visual observation. The result was evaluated in accordance with the following criterion:

good: no scratches found

poor: scratches found

### (4) Dynamic Hardness

A sample having a size of 10 mm×10 mm was fixed to a glass plate adhered to a based plate made of aluminum in a manner such that a hard coat layer was placed at the upper side. Using a dynamic ultramicro hardness meter [manufactured by SHIMADZU Corporation, the type: DUH-211] and a pyramidal pressing needle made of diamond and having an angle between edges of 115°, the pressing needle was pushed under a speed of loading of 0.0142 mN/second until the depth of penetration reached 4 μm or the force of test reached 1 mN. After this condition was kept for 15 seconds, the depth of penetration D (μm) and the applied force P (mN) were read, and the dynamic hardness was obtained in accordance with the following equation:

dynamic hardness=3.8584×P/D²

wherein 3.8584 is the constant decided in accordance with the shape of the-pushing needle.

Since the substrate film was thin, the scratch resistance and the dynamic hardness could not be measured accurately when a pressure sensitive adhesive layer was present. Therefore, the evaluation of the above properties was conducted in the absence of the pressure sensitive adhesive layer.

### Example 1

A material for forming a hard coat layer was prepared by mixing 100 parts by mass of dipentaerythritol pentaacrylate which was a pentafunctional acrylate monomer [manufactured by SARTOMER JAPAN Co., Ltd.; the trade name: “SARTOMER SR399E”; the content of solid components: 100%], 5 parts by mass of a photopolymerization initiator [manufactured by CIBA SPECIALTY CHEMICALS Co., Ltd.; the trade name: “IRUGACURE 127”; the content of solid components: 100%; 2-hydroxy-1-[4-[4-(2-hydroxy-2-methylpropionyl)benzyl]phenyl]-2-methyl-propan-1-one], 500 parts by mass of an agent for absorbing near infrared light [manufactured by SUMITOMO METAL MINING Co., Ltd.; the trade name: “YMF-01”; the concentration of a composite tungsten oxide containing 33% by mole of cesium based on the amount of tungsten: 10% by mass; the concentration of a dispersant: 4% by mass; a toluene suspension] and 100 parts by mass of toluene.

One face of a polyethylene terephthalate (PET) film having a thickness of 25 μm [manufactured by MITSUBISHI POLYESTER FILM Co., Ltd.; the trade name “PET25T600EW07”] was coated with the material for forming a hard coat layer prepared above using a Mayer bar #12 in an amount such that the thickness was 4 μm after being dried, and the formed coating layer was dried at 70° C. for 1 minute. The dried coating layer was irradiated with ultraviolet light from a high voltage mercury lamp (the luminance: 400 mW/cm²) in a manner such that the amount of light was 125 mJ/cm² to form a hard coat layer, and a near infrared light shielding film was prepared.

Using the prepared near infrared light shielding film, various properties were evaluated. The results are shown in Table 1.

The spectroscopic transmittance was measured using a ultraviolet-visible light spectrophotometer [manufactured by SHIMADZU Corporation; the type: “UV-3100”]. It was found that the transmittance of visible light (the wavelength: 380˜780 nm) was great, and the transmittance of near infrared light (the wavelength: 780˜2,100 nm) was small. The transmittance curve is shown in FIG. 4.

### Example 2

A near infrared light shielding film was prepared in accordance with the same procedures as those conducted in Example 1 except that 100 parts by mass of dipentaerythritol hexaacrylate which was a hexafunctional acrylate monomer [manufactured by NIPPON KAYAKU Co., Ltd.; the trade name: “KAYARAD DPHA”; the content of solid components: 100%] was used in place of “SARTOMER SR399E” used in Example 1.

The results of evaluation of various properties using the prepared near infrared light shielding film are shown in Table 1.

### Comparative Example 1

A near infrared light shielding film was prepared in accordance with the same procedures as those conducted in Example 1 except that 100 parts by mass of a hexafunctional acrylate oligomer [manufactured by ARAKAWA CHEMICAL INDUSTRIES, Ltd.; the trade name: “BEAMSET 575CB”; the content of solid components: 100%; containing a photopolymerization initiator] was used in place of “SARTOMER SR399E” used in Example 1, and no photopolymerization initiator was added.

The results of evaluation of various properties using the prepared near infrared light shielding film are shown in Table 1.

### Comparative Example 2

A near infrared light shielding film was prepared in accordance with the same procedures as those conducted in Example 1 except that 100 parts by mass of a trifunctional acrylate oligomer [manufactured by TOAGOSEI Co., Ltd.; the trade name: “ARONIX 3701”; the content of solid components: 100%; containing a photopolymerization initiator] was used in place of “SARTOMER SR399E” used in Example 1, and no photopolymerization initiator was added.

The results of evaluation of various properties using the prepared near infrared light shielding film are shown in Table 1.

### Comparative Example 3

A near infrared light shielding film was prepared in accordance with the same procedures as those conducted in Example 1 except that 100 parts by mass of pentaerythritol triacrylate which was a trifunctional acrylate monomer [manufactured by TOAGOSEI Co., Ltd.; the trade name: “ARONIX M-305”; the content of solid components: 100%] was used in place of “SARTOMER SR399E” used in Example 1.

The results of evaluation of various properties using the prepared near infrared light shielding film are shown in Table 1.

TABLE 1

| | Compound curable with | | Results of evaluation of properties | | | |
|---|---|---|---|---|---|---|
| | active energy ray | | curling due to | curling due to | | |
| | | number of | shrinking by | expansion by ab- | | |
| | monomer or | polymerizable | curing | sorption of water | scratch | dynamic |
| | oligomer | functional group | (before spray) | (after spray) | resistance | hardness |
| Example 1 | monomer | 5 | −5 | +2 | good | 20 |
| Example 2 | monomer | 6 | −6 | +2 | good | 25 |
| Comparative | oligomer | 6 | −3 | +6 | poor | 10 |
| Example 1 | | | | | | |
| Comparative | oligomer | 3 | −2 | +7 | poor | 5 |
| Example 2 | | | | | | |
| Comparative | monomer | 3 | −4 | +5 | good | 15 |
| Example 3 | | | | | | |

As shown by the results in Table 1, the near infrared light shielding films of the present invention (Examples 1 and 2) suppressed curling due to expansion by absorption of water and exhibited better scratch resistance and greater dynamic hardness than those of the near infrared light shielding films of Comparative Examples.

As shown in FIG. 4 in Example 1, the near infrared light shielding film of the present invention exhibited the excellent near infrared light shielding property and the excellent transmission of visible light.

### INDUSTRIAL APPLICABILITY

The near infrared light shielding film of the present invention exhibits excellent near infrared light shielding property and transmission of visible light, excellent scratch resistance and weatherability and, moreover, excellent workability in lamination to glass having a curved surface due to suppressed curling of the film. Elevation of temperature at the inside can be suppressed and the use of energy can be decreased by attaching the near infrared light shielding film of the present invention to window panes of buildings, windshield glasses of vehicles and windows of cooled showcases and refrigerated showcases. In particular, the film is advantageously used by attaching to curved glass faces of windows of vehicles such as windshield glasses of vehicles.

1. A near infrared light shielding film which comprise a hard coat layer which is formed by using a material for forming a hard coat layer comprising an agent for absorbing near infrared light and a compound curable with active energy ray and is disposed on one face of a substrate film and a pressure sensitive adhesive layer which is disposed on an other face of the substrate film, wherein the compound curable with active energy ray comprises a polyfunctional acrylate-based monomer having a functionality of five or greater as a main component.

2. The near infrared light shielding film according to claim 1, wherein the substrate film has a thickness of 50 mm or smaller.

3. The near infrared light shielding film according to claim 1, wherein the agent for absorbing near infrared light is a tungsten oxide.

4. The near infrared light shielding film according to claim 3, wherein the tungsten oxide is a composite tungsten oxide comprising cesium.

5. The near infrared light shielding film according to claim 3, wherein a content of the tungsten oxide in the hard coat layer is 5 to 60% by mass.

6. The near infrared light shielding film according to claim 1, wherein the material for forming a hard coat layer comprises a photopolymerization initiator, and the hard coat layer is formed by irradiation with ultraviolet light.

7. The near infrared light shielding film according to claim 6, wherein the photopolymerization initiator is 2-hydroxy-1-[4-[4-(2-hydroxy-2-methylpropionyl)benzyl]phenyl]-2-methylpropan-1-one.

8. The near infrared light shielding film according to claim 1, which is attached to glass having a curved surface.

9. A material for the near infrared light shielding film which is described in claim 1, wherein the pressure sensitive adhesive layer has a release film adhered to a face opposite to the face adhered to the substrate film.

10. The near infrared light shielding film according to claim 4, wherein the material for forming a hard coat layer comprises a photopolymerization initiator, and the hard coat layer is formed by irradiation with ultraviolet light.

11. The near infrared light shielding film according to claim 10, wherein the photopolymerization initiator is 2-hydroxy-1-[4-[4-(2-hydroxy-2-methylpropionyl)benzyl]phenyl]-2-methylpropan-1-one.

12. The near infrared light shielding film according to claim 11, wherein a content of the composite tungsten oxide comprising cesium in the hard coat layer is 5 to 60% by mass.

13. The near infrared light shielding film according to claim 12, wherein the substrate film has a thickness of 50 mm or smaller.

14. A material for the near infrared light shielding film which is described in claim 11, wherein the pressure sensitive adhesive layer has a release film adhered to a face opposite to the face adhered to the substrate film.

15. A material for the near infrared light shielding film which is described in claim 13, wherein the pressure sensitive adhesive layer has a release film adhered to a face opposite to the face adhered to the substrate film.
